(19) United States
(12) Patent Application Publication
(10) Pub. No.: US 2025/0119826 A1
(43) Pub. Date: Apr. 10, 2025

(54) DEVICES, SYSTEMS AND METHODS FOR THROUGHPUT ORIENTED ASSOCIATION WITH ACCESS POINT DEVICES

(71) Applicant: Cypress Semiconductor Corporation, San Jose, CA (US)

(72) Inventors: Xianmin Wang, Westfield, NJ (US); Hui Luo, Marlboro, NJ (US)

(73) Assignee: Cypress Semiconductor Corporation, San Jose, CA (US)

(21) Appl. No.: 18/983,710

(22) Filed: Dec. 17, 2024

Related U.S. Application Data
(63) Continuation-in-part of application No. 17/486,715, filed on Sep. 27, 2021, now Pat. No. 12,192,891.

(51) Int. Cl. H04W 48/20; H04W 48/10; H04W 72/542

(52) U.S. Cl. CPC H04W 48/20; H04W 48/10; H04W 72/542

(57) ABSTRACT

A method can include, by operation of an access point device (AP), between transmissions of a periodic beacon frame, communicating with each associated station devices (STAs), from communications with the STAs determining connection information for all associated STAs, and generating an information element (IE) that includes the connection information for all associated STAs. During a beacon transmission period, a beacon frame can be transmitted that includes a media access control (MAC) header, a frame body, and a frame check sequence. The frame body can include the IE. Corresponding devices and systems are also disclosed.

### CROSS-REFERENCE TO RELATED APPLICATIONS

This application is a continuation-in-part of U.S. patent application Ser. No. 17/486,715, filed on Sep. 27, 2021, the contents of which are incorporated by reference herein.

### TECHNICAL FIELD

The present disclosure relates generally to wireless networks, and more particularly to association processes for station devices (STAs) operating in environments with multiple networks (e.g., BSSs).

### BACKGROUND

Conventional WiFi systems can include basic service sets (BSSs) composed of an access point device (AP) and one or more station devices (STAs). When a new STA enters a wireless network operating environment, it can associate with an AP to join the corresponding BSS. Efficient AP association in dense deployment environments, such as stadiums, airports, or large business buildings, continues to be an ongoing problem. In these environments, WiFi hotspots (e.g., BSSs) are typically deployed with such density that tens or even hundreds of APs are operating closely to each other in a given area providing data service for a large number of STAs. Due to existing association rules, a resulting service is often distributed non-uniformly over space.

Conventionally, STAs use a “strongest signal first (SSF)” association scheme as indicated in IEEE 802.11 wireless standards. When using SSF for AP selection, a newly arrived STA scans nearby APs and will attempt to associate with the AP having the strongest signal, as determined from a receive signal strength indication (RSSI).

A drawback to conventional AP joining methods can be channel congestion. In dense deployment environments with large number of unevenly distributed STAs, it is likely that some APs experience channel congestion due to a large number of associated STAs, while other APs are lightly loaded. Such an unbalanced load among the multiple APs leads to inefficient channel resource utilization and overall network performance degradation.

It would be of great benefit to arrive at some way of increasing the efficiency of wireless systems in densely deployed environments.

### SUMMARY

A method can include, by operation of an access point device (AP), between transmissions of a periodic beacon frame, communicating with each associated station devices (STAs), from communications with the STAs determining connection information for all associated STAs, and generating an information element (IE) that includes the connection information for all associated STAs. During a beacon transmission period, a beacon frame can be transmitted that includes a media access control (MAC) header, a frame body, and a frame check sequence. The frame body can include the IE.

### BRIEF DESCRIPTION OF DRAWINGS

FIGS. 1A, 1B and 1C are diagrams showing wireless operations according to embodiments.

FIG. 2A, 2B and 2C are diagrams showing wireless operations according to other embodiments.

FIG. 3 is a diagram showing wireless operations according to additional embodiments.

FIG. 4 is a diagram of an AP broadcast transmission according to an embodiment.

FIGS. 5A and 5B are flow diagrams of methods for STA association according to embodiments.

FIGS. 6A and 6B are flow diagrams of methods for STA association according to other embodiments.

FIGS. 6C and 6D are flow diagrams of methods for STA association according to further embodiments.

FIGS. 7A, 7B and 7C are flow diagrams of STA methods of operation according to embodiments.

FIGS. 7D, 7E and 7F are flow diagrams of AP methods of operation according to embodiments.

FIGS. 8A and 8B are block diagrams of devices according to embodiments.

FIG. 9 is a diagram of an integrated circuit device according to an embodiment.

FIG. 10 is a diagram of a system according to an embodiment.

### DETAILED DESCRIPTION

Embodiments can include a distributed, high-efficiency approach to associating wireless devices (i.e., STAs) with network controller devices (i.e., APs) in dense operating environments. According to embodiments, APs can broadcast received power value (e.g., RSSI), air time, and data rates of associated STAs information. A newly arrived STA can scan for such broadcasts, measure received power, and generate estimated data rates and thus the needed air time that would result were the STA to associate with an AP, for every AP. The STA can then select an AP for association according to such estimates.

In some embodiments, a STA can establish a subset of AP candidates for association by selecting those APs with the least remaining air time that can satisfy the STA's throughput requirement. A STA can then select one AP from the subset for association. In some embodiments, such a selection can be random.

In some embodiments, a STA can exclude an AP from consideration if a received power value (e.g., RSSI) of a broadcast from the AP is below a predetermined threshold.

In some embodiments, a STA can exclude an AP from consideration if, by associating with the AP, the traffic load of the AP exceeds a predetermined threshold.

In some embodiments, if an AP does not have sufficient air time left (i.e., the AP's traffic load is full or near full), a STA can generate an estimated data rate for itself, based on a received power value from broadcasts by an AP, in referencing the power values of all associated STAs in the broadcasts, multiplying a factor less than one, which is estimated by squeezing all associated STA's air time to make room for the air time needed by the newly arrived STA (all associated STAs will proportionally slow down as the newly arrived STA associates with the AP due to competing air time).

In some embodiments, APs can operate with air time fairness, allocating the amount of air time equal to, or proportionally less than, the air time needed to achieve the expected throughput for each associated STA. If a STA needs much bigger throughput than indicated when the STA associates with the AP, the AP can put a limit on its expected throughput.

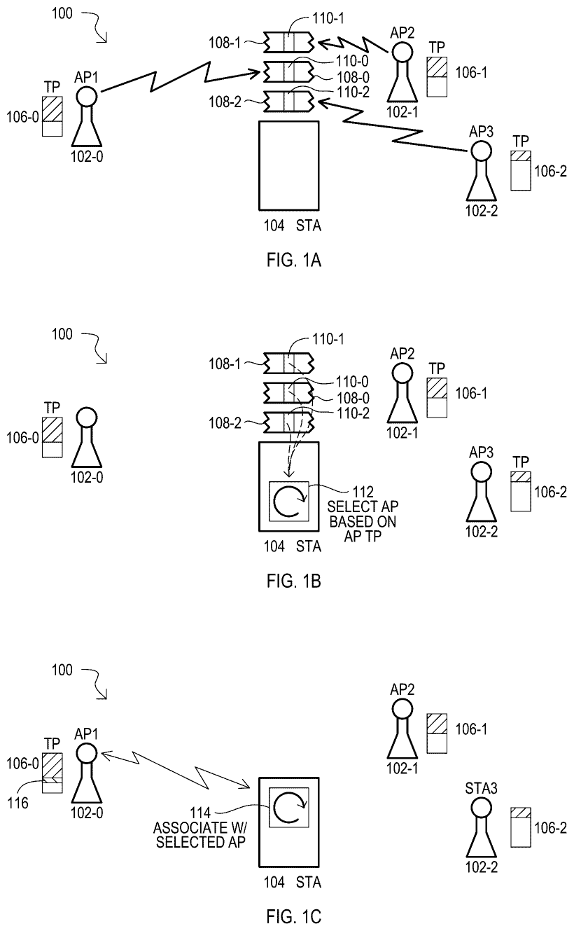

FIGS. 1A to 1C are diagrams showing operations in a wireless environment according to an embodiment. A wireless environment 100 can include multiple APs 102-0 to 102-2 and a newly arrived STA 104. Newly arrived STA 104 can seek association with one of APs 102-0 to -2.

Referring to FIG. 1A, each of APs 102-0 to -2 can issue broadcast transmissions 108-0 to -2. Broadcast transmissions (108-0 to -2) can be detected by any compatible STA in range of the originating AP. In some embodiments, broadcast transmissions (108-0 to -2) can be periodic beacons transmitted by APs (102-0 to -2). In some embodiments, broadcast transmissions (108-0 to -2) can be beacon frames compatible with one or more IEEE 802.11 wireless standards. Broadcast transmissions (108-0 to -2) can each include communication information 110-0 to -2 corresponding to the APs (102-0 to -2). Communication information (110-0 to -2) can take any suitable form that can enable a newly arrived STA 104 to estimate its own data rate with respect to each AP (102-0 to -2), as well as available air time for each AP (102-0 to -2). In some embodiments, communication information can include any of: receive power for each associated STA, a modulation scheme and/or coding rate for each associated STA, and/or air time for each associated STA at its AP.

Referring to FIG. 1B, a newly arrived STA 104 can extract the communication information (110-0 to -2) from broadcast transmissions (108-0 to -2). STA 104 can execute a selection process 112 to select one of the APs (102-0 to -2) for association based on communication information (110-0 to -2). In some embodiments, a selection process can include selecting from one or more APs having a lowest available air time, however, alternate embodiments can include processes based on other AP traffic metrics.

Referring to FIG. 1C, after selecting an AP, a STA 104 can execute an association process 114 with the selected AP. In the embodiment shown, STA 104 selects AP1, which is one of the APs having a lowest available throughput 106-0. Once newly arrived STA 104 is associated with AP1 102-0, AP1 its available air time 106-0 will grow smaller, as a new portion of throughput 116 is dedicated to STA 104.

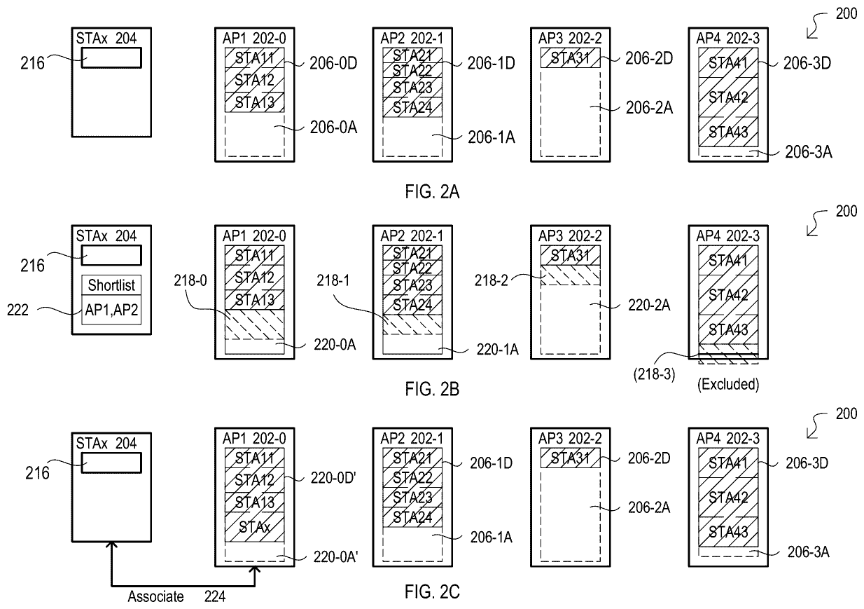

FIGS. 2A to 2C are diagram showing operations for a wireless environment according to additional embodiments. In some embodiments, the operations of FIGS. 2A to 2C can be versions of those shown in FIGS. 1A to 1C. A wireless environment 200 can include APs 202-0 to -3, a joining STA 204, and various other STAs (not shown). A total air time of APs (202-0 to -3) is represented by a rectangle, and includes dedicated air time (206-0D to 206-3D) and available air time (206-0A to 206-3A).

FIGS. 2A to 2C show an arrangement in which APs can operate with air time fairness. With air time fairness, an AP can allocate air time based on a STAs expected throughput. Thus, AP1 202-0 is shown associated with STA11, STA12 and STA13 (not shown), and allocates air time sufficient to enable equal throughput among the STAs. Similarly, AP2 202-1 allocates equal throughput to STA21, STA22, STA23, STA24 (not shown). AP3 202-2 is associated with only one station device, STA31 (not shown). AP4 202-3 is associated with STA41, STA42, STA43 (not shown).

In some embodiments, newly joining STAx 204 can have its own throughput value 216.

FIG. 2A shows a status of the various devices before STAx 204 has selected an AP for association. STAx 204 can detect wireless broadcasts messages from each AP (202-0 to -3) which can include information for STAs associated with that AP. AP information can take any suitable form, as described herein or equivalents. From such information, STAx 204 can estimate its air time for each AP (202-0 to -3) based on its throughput value 216 and determine the available throughput (206-0A to -3A) for all APs (202-0 to -3).

FIG. 2B shows operations following STAx 204 receiving broadcast transmissions. STAx 204 can generate estimated air time values and select AP candidates for association. STAx 204 can estimate its effect were it to associate with each AP (202-0 to -2). Such operations are represented in FIG. 2B by estimated STA air time values 218-0 to 218-3 added to the dedicated air time for each AP (202-0 to -3).

Referring still to FIG. 2B, a STA can select AP candidates for association according to throughput metrics for the APs. In some embodiments, selection can be based, at least in part, on lowest available air time. It is understood that if the addition of the air time of a STA would exceed the available air time of an AP, the AP can be excluded as a candidate for association. This is represented by AP4 202-3 in FIG. 2B. Because the association of STAx with AP2 202-3 is estimated to exceed the available air time of AP4 202-3, STAx can exclude the AP2 202-3 from consideration for association. In the embodiment shown, AP1 202-0 and AP2 202-1 have a lowest estimated available air time 220-0A/220-1A, and so are considered candidates for association (shown by short list 222). AP3 202-2 can be excluded from consideration as its estimated available air time can be determined to be too large. Exclusion of a high available throughput/air time AP, like AP3 202-2, can advantageously reserve the AP for other (possibly high throughput) STAs that may arrive in the future.

Selection of AP candidates based on lowest estimated available air time (or greatest estimated aggregate air time) can take any suitable form. In some embodiments, a STA can select some minimum number of APs for consideration (e.g., two). However, alternate embodiments can include other considerations, including but not limited to: a relative difference between estimated air time values (i.e., if there are three AP candidates, but one has an available air time substantially greater than the others, the larger available air time AP is excluded); number of STAs already associated with the AP (an AP with fewer associated STAs may be preferred for association over those with more associated STAs). In some embodiments, selection of one AP from multiple candidates can be a random or pseudorandom selection to prevent multiple STAs executing a same association method from attempting to associate with the same AP.

FIG. 2C shows STAx selecting and associating 224 with AP1 202-0. With the association of STAx, AP1 202-0 can have a revised, smaller, available air time 206-0A′ (and larger aggregate dedicated air time 202-0D′).

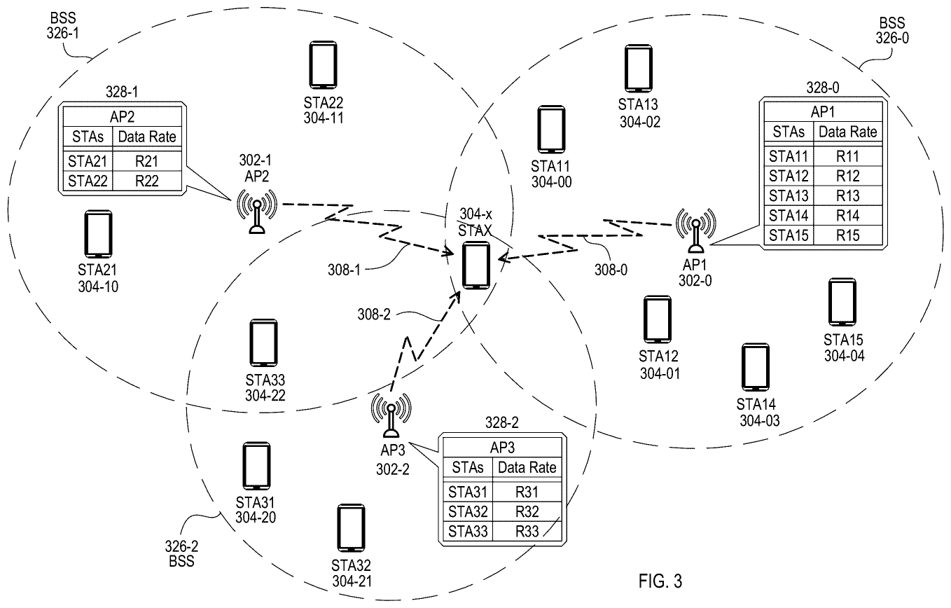

FIG. 3 is a diagram showing operations in a wireless environment 300 according to another embodiment. Wireless environment 300 can include a number of basic service sets (BSSs) 326-0 to -2 that can each be compatible with an IEEE 802.11wireless standard. Each BSS (326-0 to -2) can include an AP associated with a set of STAs. BSS 326-0 includes AP1 302-0 associated with STA11 to STA15 (304-00 to -04). BSS 326-1 includes AP2 302-1 associated with STA21 and STA22 (304-10/11). BSS 326-2 includes AP3 302-2 associated with STA31 to STA33 (304-20 to -22). BSSs (326-0 to -2) can have overlapping operating ranges. Each of APs (302-0 to -2) can maintain traffic information 328-0 to -2 that results from associated STAs. In some embodiments, traffic information (328-0 to -2) can include a data rate for each associated STA. In some embodiments, some or all of APs (302-0 to -2) can operate with air time fairness. However, in alternate embodiments APs (302-0 to -2) may not use air time fairness.

Referring still to FIG. 3, STAx 304-x can be an unassociated STA in the operating environment, in range of all BSSs (326-0 to -2). STAx 304-x can receive beacon transmissions 308-0 to -2 from APs (302-0 to -2). Beacon transmissions (308-0 to -2) can include information for STAs associated with APs (302-0 to -2), which can take the form of any of those described herein, including but not limited to: any or all of data rate information (328-0 to -2); available air time; modulation scheme; or symbol rate.

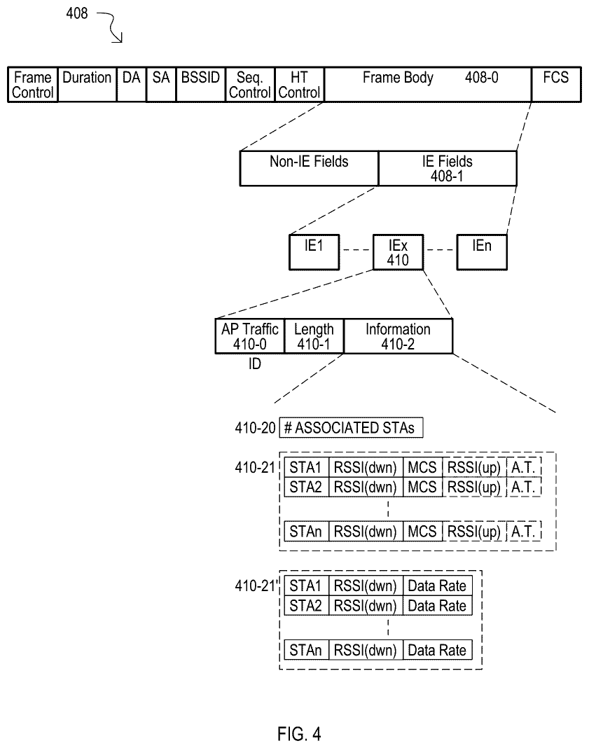

According to embodiments, an unassociated STA can receive a broadcast transmission from APs that include traffic information for the APs. From such traffic information, a newly arrives STA can estimate its own data rate and effect on AP air time were the STA to associate with the AP. Such broadcast transmissions can take any suitable form according to the wireless protocol. FIG. 4 shows a broadcast transmission according to one embodiment, and should not be construed as limiting.

FIG. 4 is a diagram of a broadcast transmission 408 according to an embodiment. A broadcast transmission 408 can include a beacon frame compatible with one or more IEEE 802.11 wireless standards. A broadcast transmission 408 can have various fields, including a frame control, duration, destination address, source address, basic service set ID, sequence control, high throughput control, a frame body 408-0, and frame check sequence. A frame body 408-0 can include non-information element (IE) fields and IE fields 408-1. IE fields 408-1 can include a number of IEs, including an AP Traffic IE 410. An AP Traffic IE 410 can include an IE ID field 410-0, a length field 410-1 and an information field 410-2. An IE ID field 410-0 can identify the IE as including AP traffic information (e.g., for use by a newly arrived ST). A length value 410-1 can indicate a size of the IE. IE information 410-2 can include traffic (or communication) information according to any of the embodiments described herein and equivalents.

In some embodiments, IE information 410-2 can include, but is not limited to, the number of STAs associated with the AP 410-20 and data for each STA associated with the AP 410-21. In the embodiment shown, data for each associated STA 410-12 can include: a downlink power value (RSSI (dwn)) (i.e., the power value at the STA of transmissions from AP) and a modulation and/or coding scheme for the STA (MCS). Optionally, IE information can also include an uplink power value (RSSI (up)) and/or an air time value (A.T.). An air time value (A.T.) can include air time used by a STA (e.g., running average of up/down time) and/or available air time for the AP. From such traffic information, newly arrived STA can estimate its own data rate for the AP.

As noted herein, traffic information can take various forms. FIG. 4 shows associated STA information 410-21′ provided in a beacon for an alternate embodiment. STA information 410-21′ can include RSSI (dwn) as well as a data rate for the associated STA (Data Rate). A Data Rate for the associated STA can be a data rate estimated by the AP or by the associated STA based on modulation/coding and power values. Alternatively, a Data Rate for the associated STA can be an actual data rate determined by the associated STA for the AP over a given time period. A Data Rate for the associated STA can be for downlink data (from AP to STA), uplink data (from STA to AP), or combinations thereof. In some embodiments, such Data Rate values can be averages over time.

While the devices and operations disclosed show various methods according to embodiments, additional methods will now be described with reference to a number of flow diagrams.

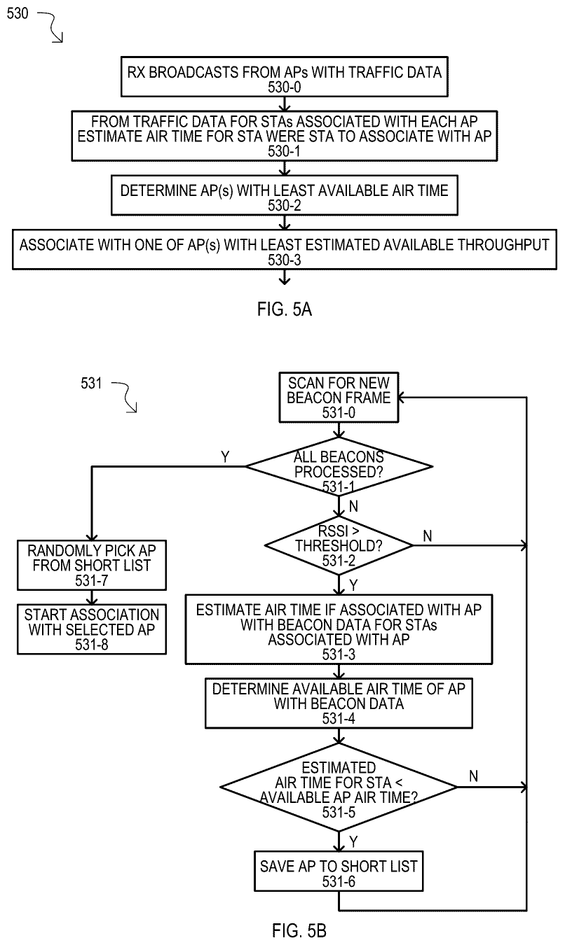

FIG. 5A is a flow diagram of a method 530 according to an embodiment. A method 530 can be executed by a STA device when deciding to associate with an AP when in the range of multiple APs. A method 530 can include receiving broadcasts from APs that include traffic data 530-0. Such an action can include receiving broadcast transmissions from multiple APs, where such broadcast transmissions can include traffic information for the AP as described herein, or equivalents. From the traffic data for the STAs associated with an AP, a STA can estimate its air time were the STA to associate with the AP 530-1. In some embodiments, such an action can include using a received power value for the broadcast for each AP.

A method 530 can further include determining APs with lowest available estimated available air time 530-2. Such an action can include using traffic information from each AP. In some embodiments, each AP can provide an available air time value that it has generated based on traffic over a predetermined time period. However, in other embodiments, an AP can derive an available air time for an AP by aggregating estimated air times for the STAs associated with the AP, and subtracting such a value from a maximum air time. In some embodiments, a set can include multiple APs. However, in other embodiments, a set can include but one AP. A STA can then associate with one of the APs with least estimated available air time 530-3. In some embodiments, such an action can include randomly selecting one AP from a set of multiple APs.

FIG. 5B is a flow diagram of a method 531 according to another embodiment. A method 531 can be executed by a STA seeking association with an AP in a dense operating environment. In some embodiments, a method 531 can be compatible with communications according to one or more IEEE 802.11 wireless standards. A method 531 can include scanning for new beacon frames 531-0. In some embodiments, such an action can include a STA monitoring one or more wireless channels.

A method 531 can continue to monitor channel(s) until all beacons have been processed 531-1. In some embodiments, such an action can include a STA monitoring one or more wireless channels over one or more beacon intervals as indicated by a protocol in use. A beacon interval can be predetermined time period over which a beacon is repeated. In addition or alternatively, such an action can also include monitoring until a STA begins to receive beacons from the same APs.

While all beacons have not been processed 531-1 (N from 531-1), a method 531 can determine whether a receive power of a beacon is above a predetermined threshold 531-2. In some embodiments, this can include determining if a received signal strength indicator (RSSI) is above a predetermined value. If a receive power of a beacon is not above a threshold (N from 531-2), a method 531 can continue scanning for new beacons 531-0.

If a receive power of a beacon is above a threshold (Y from 531-2), a method 531 can estimate air time if associated with the AP using beacon data for STAs associated with the AP 531-3. In some embodiments, an action can include using power values and modulation/coding schemes for associated STAs, and finding a closest matching STA, or estimating from values of one or more STAs. A method 531 can determine available air time for the AP from beacon data 531-4. Such an action can include, but is not limited to, estimating available air time by aggregating air time for associated STAs or from an air time value provided by an AP.

If a STA estimated air time is not less than an available air time for the AP (N from 531-5), a method 531 can return to scanning for beacons. As will be shown herein, in some embodiments, if all APs do not have sufficient available air time to accommodate a STAs throughput needs, the STA can scale down its estimated air time.

If a STA estimated air time is less than an available air time for the AP (Y from 531-5), the STA can be saved to a “short list” 531-6. A short list can be a list of candidate APs for association. In some embodiments, a short list can be limited to those APs having the least available air time.

When all beacons have been processed (Y from 531-1), a method 531 can randomly select one AP from the candidate list (e.g., short list) 531-7. A STA can then associate with the selected AP 531-8.

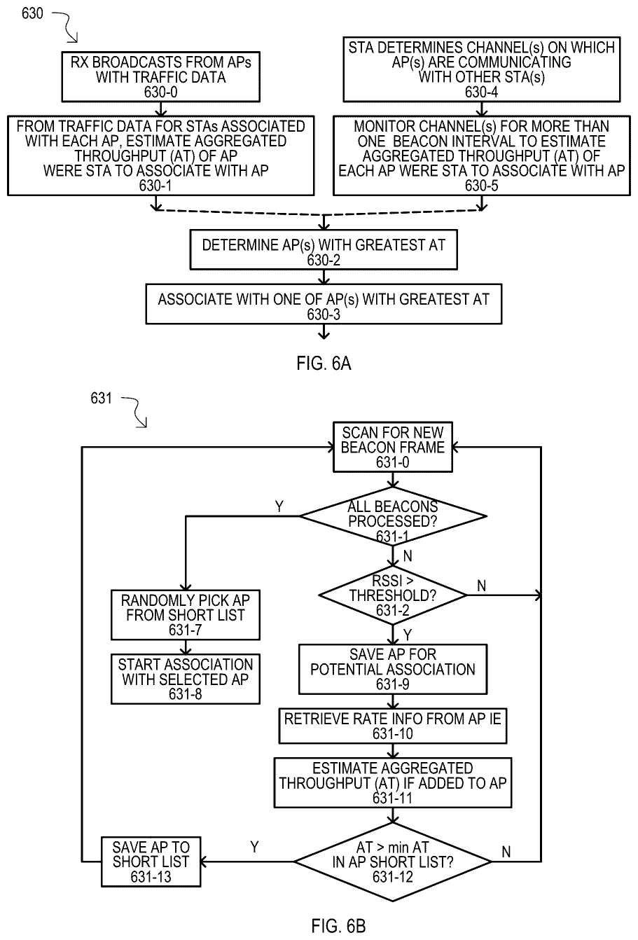

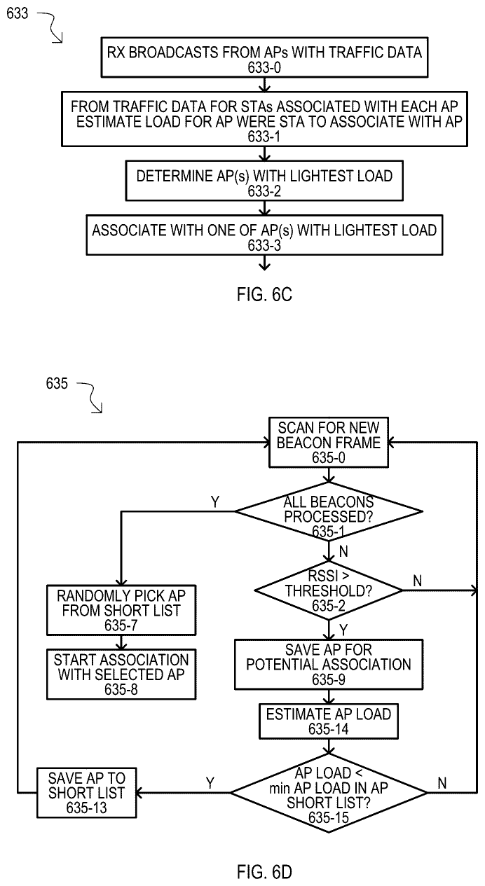

FIG. 6A is a flow diagram showing methods 630 according to further embodiments. Methods 630 can include a STA deciding which AP to join based on estimated aggregate throughput were the STA to join the AP. In one method, a STA can receive broadcasts from APs that include traffic data 630-0. Such an action can include those described for FIG. 5A. From the traffic data for the STAs associated with an AP, a STA can estimate an aggregate throughput (AT) for the AP were the STA to associate with the AP 630-1. AT can include any suitable measurement of data transfer over time for all STAs associated the AP. AT can include upload data throughput, download data throughput, and combinations thereof.

A method 630 can further include determining APs with greatest AT (were the STA to associate with the AP) 630-2. A STA can then associate with one of the APs with a highest AT 630-3. In some embodiments, such an action can include randomly selecting one AP from a set of multiple AP candidates with a highest AT.

In addition or alternatively, a method 630 can include a STA device determining on which channels one or more APs are communicating with other STAs 630-4. Such an action can include scanning channels for traffic and determining which APs are transmitting and/or receiving on such channels. In some embodiments, such an action can include determining which transmissions on a channel correspond to which AP. A method 630 can monitor each channel for more than one beacon interval to estimate an AT for each detected STA, were the AP to associate with such a STA 630-5. That is, a STA can estimate AT without relying on broadcasts (e.g., beacons) from an AP. A method 630 can continue onto actions 630-2 and 630-3, as described.

FIG. 6B is a flow diagram of a method 631 according to another embodiment. A method 631 can be executed by a STA seeking association with an AP in a dense operating environment. In some embodiments, a method 631 can be compatible with communications according to one or more IEEE 802.11 wireless standards. A method 631 can be conceptualized as including three steps for selecting an AP from among APs of the operating environment. First, APs can be selected based on first criteria (e.g., power, RSSI) which can make up a “long” list of candidates. Second, APs from the long list can be narrowed down based on the estimated effect of the STA associating with each AP (e.g., air time, aggregate throughput, number of total STAs associated, AP load) to form a short list. An AP from the short list can then be selected at random for association.

In the embodiment of FIG. 6B, a method 631 can include scanning for new beacon frames 631-0, monitor channel(s) until all beacons have been processed 631-1, and determine if a receive power for APs is above a predetermined threshold 631-2. Such actions can take the form of those described for FIG. 5B or equivalents.

If a receive power of a beacon is above a threshold (Y from 631-2), a method 631 can save the AP for potential association (e.g., a long list) 631-9. From an IE transmitted in a beacon frame of each AP for potential association, a STA can retrieve transmission rate information 631-10. Such information can take the form of any of that shown herein or an equivalent. A method 631 can estimate an AT for each AP were the STA to be added (i.e., associate with) the AP 631-11. If an estimated AT for an AP is less than a minimum AT for APs on a short list (N from 631-12), a method 631 can return to scanning for beacons. Such an action can include adding the AP to a short list, if the short list is empty.

If an estimated AT for an AP is less than a minimum AT for APs on a short list (Y from 631-12), a method 631 can save the AP to a short list 631-13. Such an action can include adding the AP to a short list, if the short list is empty.

When all beacons have been processed (Y from 631-1), a method 631 can randomly select one AP from the candidate list (e.g., short list) 631-7. A STA can then associate with the selected AP 631-8.

In this way, a STA can determine candidate APs to associate with based on aggregate throughput, and randomly associate with one such AP.

FIG. 6C is a flow diagram of a method 633 according to another embodiment. A method 633 can include receiving broadcasts from APs that include traffic data 633-0. Such an action can include those described for FIG. 5A. From such traffic data, a STA can estimate a load for each AP were the STA to associate with the AP 630-1. An estimated load can take any suitable form, including but not limited to a number of STAs associated with the AP, the bandwidth for each STA associated with an AP, a number of AP processes or threads dedicated to the associated STAs.

A method 633 can further include determining which APs have a lightest load (were the STA to associate with the AP) 633-2. A STA can then associate with one of the APs having the lightest loads 633-3. In some embodiments, such an action can include randomly selecting one AP from a set of multiple APs

FIG. 6D is a flow diagram of a method 635 according to another embodiment. A method 635 can be executed by a STA seeking association with an AP in a dense operating environment, and in some embodiments, a method 635 can be compatible with communications according to one or more IEEE 802.11 wireless standards. A method 635 can include actions like those shown in FIG. 6B, and such like actions are referred to by the same reference characters, but with the leading digits being “635” instead of “631”.

FIG. 6D can differ from FIG. 6B in that after saving an AP for potential association (635-9), a method 635 can estimate a load for an AP (were the STA to associate with the AP) 635-14. An AP load can take the form of any of those described herein and equivalents.

If an estimated AP load is less than a minimum AP load for APs on a short list (Y from 635-15), a method 635 can save the AP to a short list 635-13. Such an action can include adding the AP to a short list, if the short list is empty.

In this way, a STA can determine candidate APs for associate based on AP load, and randomly associate with one such AP.

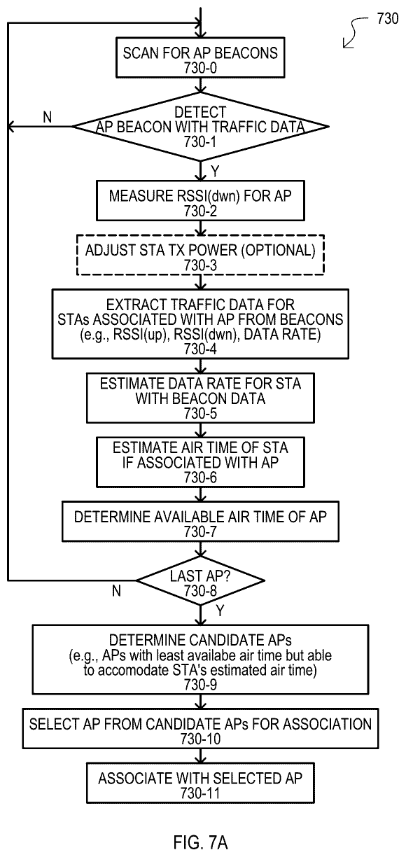

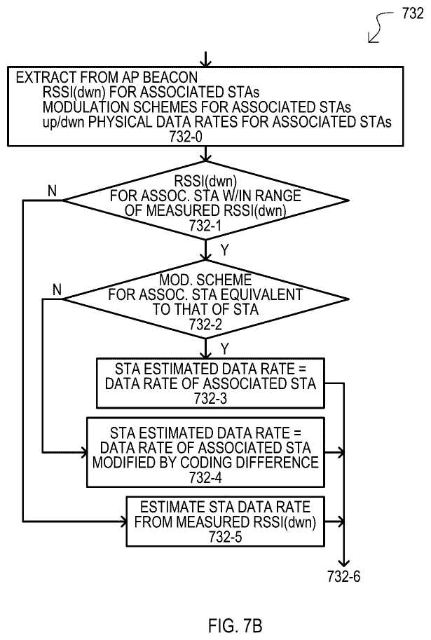

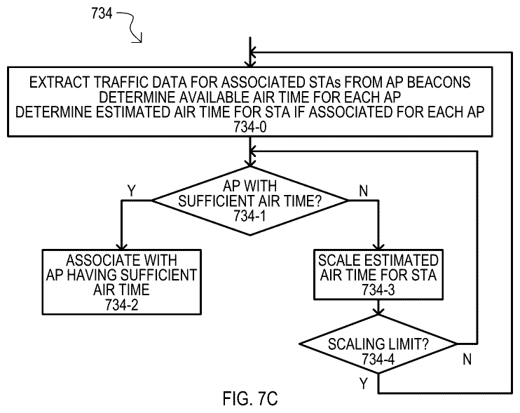

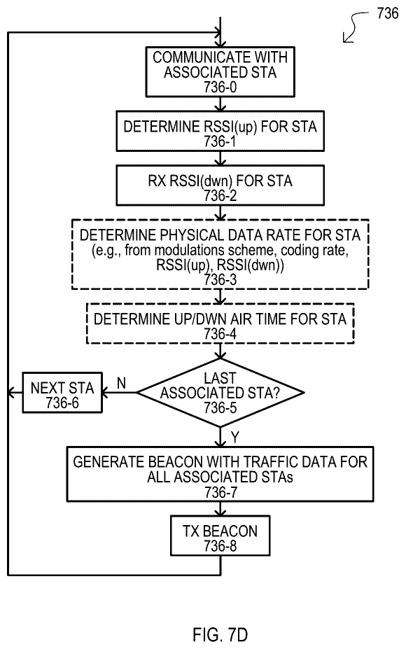

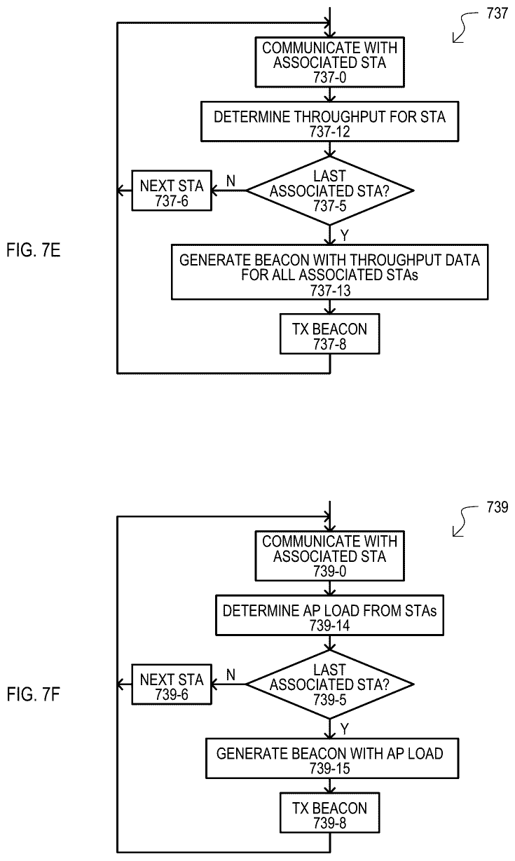

FIG. 7A is a flow diagram of a method 730 according to another embodiment. A method 730 can be executed by a STA that is newly arrived at an operating environment having multiple APs. A method 730 can include scanning for beacons 730-0. Such an action can include scanning for AP beacons broadcast according to one or more IEEE 802.11 wireless standards. If AP beacons with traffic data are not detected (N from 730-1), a method 730 can continue to scan for AP beacons.

If an AP beacon with traffic data is detected (Y from 730-1), a method 730 can detect the receive power for the AP beacon (e.g., RSSI(dwn)) 730-2. Optionally, a method can 730 can adjust a transmit power for the STA 730-3. Such an action can include adjusting transmit power based on the operating environment, including the detected RSSI(dwn) for the AP.

A method 730 can include extracting traffic data for other STAs associated with the AP from the beacon 730-4. Such an action can include extracting traffic information from a beacon, including but not limited to data for each associated station, including any of: RSSI(dwn), RSSI(up), data rate, or modulation/coding scheme. After extracting data for STAs associated with the AP, an estimated data rate for the STA can be determined 730-5. Such an action can include examining traffic data for the associated STAs, and determining a closest matching associated STA based on power levels and/or type of modulation or coding. Such an action can include extrapolating, or using similar estimation algorithms, in the event there is no sufficiently matching associated STA. With an estimated data rate, a method 730 can estimate a resulting air time, were the STA to associate with the AP 730-6. Such an action can include using an estimated data rate with an expected throughput to arrive at an air time. An expected throughput can be the amount of data expected to be transmitted in a predetermined period of time, and can be based on the type of STA device and/or function the STA performs, or can take into account historical data regarding up/down throughput for the STA. If beacon data has not been gathered for all suitable APs in the operating environment (N from 730-8), a method continue scanning (return to 730-0).

If beacon data for all suitable APs has been acquired (Y from 730-8), a method can determine candidate APs for association 730-9. In some embodiments, candidate APs can be APs having the least available air time, but still capable of accommodating the STAs estimated air time. An AP can be selected from the candidate APs 730-10. Such an action can include a random selection. However, other embodiments can include additional factors, such as how many STAs are already associated with the AP. A STA can then associate with the selected AP 730-11.

FIG. 7B is a flow diagram of another method 732 according to an embodiment. A method 732 can be executed by a joining STA to determine its estimated data rate were it to join an AP using beacon data from the AP. A method 732 can include extracting data from an AP beacon 732-0. Such an action can include extracting data as described for any of the embodiments herein, including but not limited to RSSI(dwn) data for each associated STA, modulation/coding schemes for each associated STA, and possibly actual or estimated data rates for each associated STA.

A method 732 can compare receive power levels of STAs associated with the AP to receive power levels of the joining STA 732-1. Such an action can include finding a STA with a closest matching power level from all STAs associated with an AP. If a receive power for an associated STA is sufficiently close (Y from 732-1), a modulation scheme for the associated can be compared to that of the joining STA 732-2. If a modulating scheme of the associated STA is the same or equivalent to that or the joining STA (Y from 732-2), the joining STA can use the data rate of the associated STA as its estimated data rate. If a modulating scheme of the associated STA is not the same or equivalent (N from 732-2), the joining STA can generate an estimated data rate the data rate of the other STA adjusted according to the modulation/coding difference 732-4.

If there is no associated STA with a suitable connection profile (N from 732-1 or N from 732-2), a method 732 can estimate a data rate from its measured RSSI(dwn) value 732-5. In some embodiments, this can include using a table or formula that generates an estimated data rate from an RSSI(dwn) value and modulation/coding scheme (which can be derived from the beacon). A method 732 can then proceed to determining whether or not to associate with an AP 732-6 as described for various embodiments herein, or equivalents.

FIG. 7C is a flow diagram of a method 734 for scaling data rate estimations according to an embodiment. A method 734 can be executed by a newly arrived STA in a dense deployment environment that determines no AP has sufficient air time for its estimated throughput needs. A method 734 can include extracting traffic data from AP beacons, determining an available air time for all APs, and determining an estimated air time for the newly arrived STA were it to associate with each AP 734-0. Such actions can include those described herein or equivalents.

A method 734 can determine if there is one or more APs with sufficient available air time to meet the throughput needs of the newly arrived STA 734-1. If such an AP exists (Y from 734-1), a method 732 can include selecting the AP for association according to the various approaches described herein, or equivalents.

If there is not an AP with sufficient available air time (N from 734-1), a method 734 can scale its estimated air time down (e.g., by a factor less than one) 734-3. Providing such scaling has not reached a limit (N from 734-4), a method 732 can return to determining if the scaled down air time can be met by an AP (return to 734-1). If a scaling limit has been reached (Y from 734-4), a method 734 can return to scanning for APs. A scaling limit can be a predetermined limit on data throughput or performance for the newly arrived STA or an application executed by the newly arrived STA.

FIG. 7D is a flow diagram of a method 736 according to another embodiment. A method 736 can be executed by an AP to generate a broadcast transmission for STAs seeking association. A method 736 can be compatible with communications according to one or more IEEE 802.11 wireless standards.

A method 736 can include communicating with associated STAs 736-0. Such an action can include an AP communication with a STA through a collision based protocol (e.g., RTS-CTS) and/or an AP-STA communications occurring in a predetermined time period (e.g., target wake time). An AP can initiate such communications or a STA can initiate such communications. Such communications can be a single communication (transmission of downlink data or reception of uplink data), or can be cumulative (multiple such communications). From such communications with a STA, a method 736 can determine an RSSI(up) value for the STA 736-1, and can receive RSSI(dwn) values from the STA 736-2.

Optionally, a method 736 can determine a physical data rate for the STA 736-3. Such an action can include estimating a physical data rate for the STA based on a data for the link with the STA (e.g., modulation/coding scheme, RSSI(up), RSSI(dwn)). In some embodiments, a STA may transmit its own data rate value, which can be an actual downlink data rate, or can be an estimated data rate. As understood from embodiments herein, in other embodiments a newly arrived STA may perform this function based on beacon data provided by an AP.

Optionally, a method 736 can determine an air time for each STA 736-4. Such an action can include recording and/or determining up/dwn transmission time for the STA in a given time period, including a running time period (e.g., running average). As in the case of 736-3, in other embodiments a newly arrived STA may perform this function based on beacon data provided by an AP.

While all associated STAs have not been evaluated (N from 736-5), a method 736 can advance to a next associated STA 736-6 and determine traffic information for the STA (return to 736-0). When traffic data has been acquired for all associated STAs (Y from 736-5), a method 736 can generate a beacon containing such data 736-7. It is understood that such beacon data can take the form of any of those described herein or equivalents, and includes data sufficient for a newly arrived STA to estimate its own data rate/air time were it to associated with the AP as well as the available air time of the AP. The beacon can then be transmitted 736-8.

FIG. 7E is a flow diagram of a method 737 according to another embodiment. A method 737 can be executed by an AP to generate a broadcast transmission for STAs seeking association. A method 737 can be compatible with communications according to one or more IEEE 802.11 wireless standards. A method 737 can include actions like those of FIG. 7D, and such like actions are referred to by the same reference characters, but with the leading digits being “737” instead of “736”.

A method 737 can differ from that of FIG. 7D in that from communications with an associated STA 737-0, an AP can determine a throughput corresponding to the STA 737-12. A throughput can take the form of any of those described herein or equivalents. Further, once determinations have been made for a last associated STA (Y from 737-5), a method 737 can generate a beacon with throughput data for all associated STAs 737-15.

FIG. 7F is a flow diagram of a method 739 according to a further embodiment. A method 739 can be executed by an AP to generate a broadcast transmission for STAs seeking association. A method 739 can be compatible with communications according to one or more IEEE 802.11 wireless standards. A method 739 can include actions like those of FIG. 7D, and such like actions are referred to by the same reference characters, but with the leading digits being “739” instead of “736”.

A method 739 can differ from that of FIG. 7D in that from communications with an associated STA 739-0, an AP can determine a load for the AP created by associated STAs 739-14. An AP load can take the form of any of those described herein or equivalents. Further, once determinations have been made for a last associated STA (Y from 739-5), a method 739 can generate a beacon with AP load data for all associated STAs 739-15.

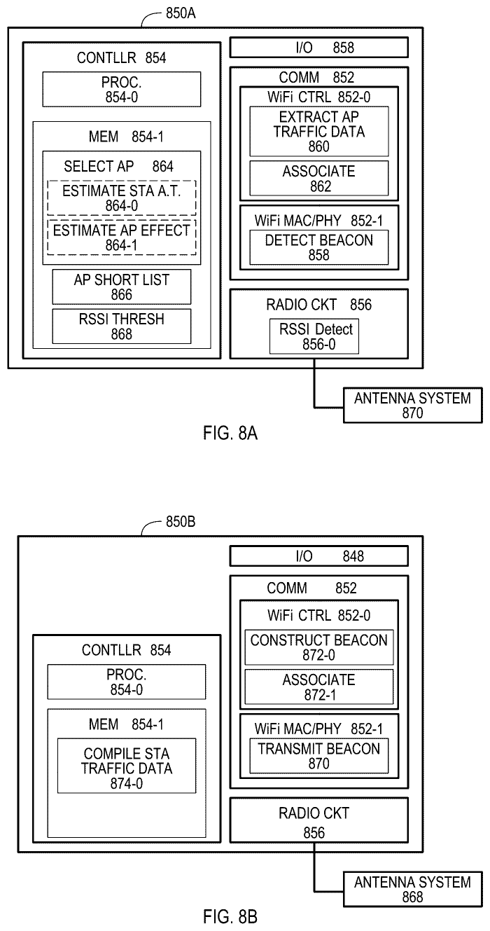

FIG. 8A is a block diagram of a device 850A according to embodiment. A device 850A can part of a STA as described herein or equivalents. A device 850A can include communication circuits 852, controller 854, radio circuits 856, and input/output (I/O) circuits 858. Communication circuits 852 can include WiFi control circuits 852-0 and WiFi MAC/PHY circuits 852-1. WiFi control circuits 852-0 can execute communication operations compatible with one or more IEEE 802.11 wireless standards. This can include extracting AP traffic data from received packets 860, as well as conventional association functions for associating with an AP 862. WiFi MAC/PHY circuits 852-1 can control data transmission and reception according to one or more IEEE 802.11 wireless standards. Accordingly, WiFi MAC/PHY circuits 852-1 can detect and receive beacon packets 858, including beacon packets having AP traffic information.

A controller 854 can control transmissions by communication circuits 852. In some embodiments, a controller 854 can include circuits (or instructions executable by circuits) for controlling wireless transmissions according to other processes (e.g., applications). In the embodiment shown, a controller 854 can include a processor section 854-0 and a memory section 854-1. In the embodiment shown, a memory section 854-1 can store instructions for executing processes, including an AP selection process 864. An AP selection process 864 can select an AP for association according to any of the embodiments disclosed herein, or an equivalent. In some embodiments, AP selection process 864 can include a STA air time estimation section 864-0 and AP effect estimation section 864-1. A STA air time estimation section 864-0 can estimate the air time for its throughput needs with respect to each detected AP, based on a traffic information from the AP. Such actions can include any of those described herein, or equivalents. In some embodiments, STA air time estimation section 864-0 can use an RSSI(dwn) value detected by radio circuit 846. An AP effect estimation section 864-1 can estimate an effect of the STA on the AP were the STA to associate with the AP. Such an estimated effect on an AP can be used to develop a short list of AP candidates for association. Estimated effects on an AP can include any of those described herein or equivalents, including but not limited to air time, aggregated throughput and load.

In some embodiments, a memory section 854-1 can store various values for an AP selection process 864. In the embodiment shown, memory section 854-1 can store a short list of candidate APs 866. Such a short list can take the form of any of those described herein, or an equivalent, including a list of APs having the least available air time, yet still able to serve the throughput requirements of the device 850A. A memory section 854-1 can also store one or more RSSI threshold values 868. RSSI threshold values 868 can be used to discard APs from consideration as association candidates (i.e., if an RSSI for an AP is below the RSSI threshold, the AP is not considered for association).

Radio circuits 856 can include circuits for receiving and transmitting signals according to one or more IEEE 802.11 wireless standards. Radio circuits 856 can include any suitable circuits according to a selected protocol, and in some embodiments can include baseband circuits. In the embodiment shown, radio circuits 856 can include RSSI detect circuits 856-0 which can generate an RSSI value for received packets/data frames, including beacon frames. In some embodiments, radio circuits 856 can transmit/receive on any internationally recognized industrial, scientific, or medical (ISM) band, as well as portions of such bands. In some embodiments, radio circuits 856 can operate in any or all of 2.4 GHZ, 5 GHz or 6 GHz bands.

I/O circuits 858 can enable control of device 850A by another system or device. I/O circuits 858 can include circuits that enable communication with the device according to any suitable method, including any of various serial data communication standards/methods including but not limited to: serial digital interface (SDI), universal serial bus (USB), universal asynchronous receiver transmitter (UART), I²C, or I²S.

When included as part of a system, device 850A can include one or more antenna systems 870 connected to radio circuits 856. Antenna system 870 can include antennas for receiving and transmitting over one or more channels. In some embodiments, antenna system 870 can be configured for data transmission and reception compatible with one or more IEEE 802.11 wireless standards.

FIG. 8B is a block diagram of a device 850B according to embodiment. A device 850B can be part of an AP as described herein or equivalents. A device 850B can include circuits like those of FIG. 8A, and such circuits can operate in the same or an equivalent fashion. As in the case of FIG. 8A, a device 850B can execute communication operations compatible with one or more IEEE 802.11 wireless standards. However, such operations can be in the role of an AP, and so can include constructing beacons 872-0, including beacons with traffic information as described herein or equivalents, as well as association functions 872-1 for associating with a STA. WiFi MAC/PHY circuits 852-1 can transmit beacon packets 870, including beacon packets having traffic information.

In the embodiment shown, a memory section 854-1 can include instructions for compiling STA traffic data 874-0. Such instructions can include maintaining/acquiring power values for each link with an associated STA (e.g., RSSI(up), RSSI(dwn)) and recording a modulation/coding scheme for the associated STA if more than one scheme is supported. In some embodiments, such instructions can include generating and maintaining an available air time value for the AP that takes into account the aggregate air time for all associated STAs. In addition or alternatively, STA traffic data 874-0 can include throughput values for each STA and/or an aggregate throughput value for all currently associated STAs, as well as load values for STA, which can include a number of associated STAs. In some embodiments, STA traffic data 874-0 can be compiled, including updated, between beacon transmissions.

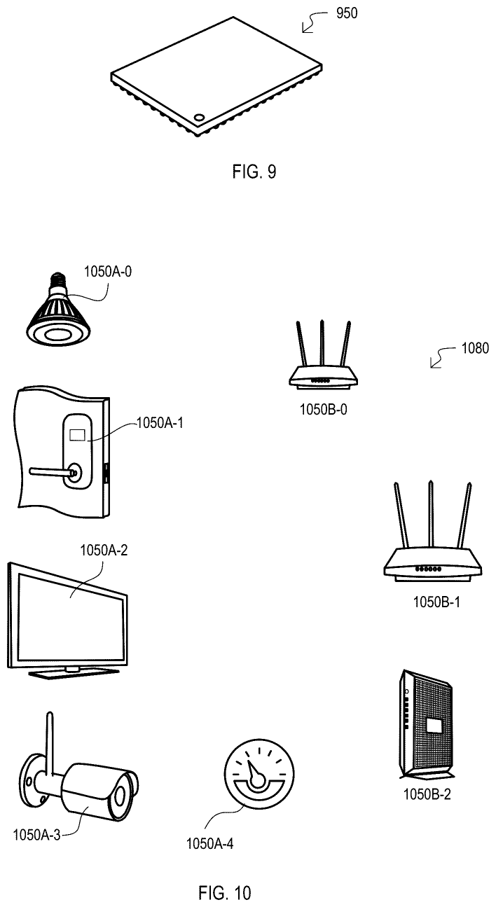

While embodiments can include systems and devices with various interconnected components, embodiments can also include unitary devices which can enable devices to execute association processes that can lead to efficient, balanced access to APs in dense operating environments, as describe herein or equivalents. In some embodiments, such unitary devices can be advantageously compact single integrated circuits (i.e., chips). FIG. 9 show one particular example of a packaged single chip wireless device 950. Such a device 950 can include circuits for providing the STA and/or AP functions described herein and equivalents. In some embodiments, a device 950 can include circuits like those shown in FIG. 8A and/or 8B.

However, it is understood that a device according to embodiments can include any other suitable integrated circuit packaging type, as well as direct bonding of a device chip onto a circuit board or substrate.

FIG. 10 shows a system 1080 according to an embodiment. A system 1080 can include various local devices 1050A-0 to -4 and gateway devices 1050B-0 to -2. Local devices (1050A-0 to -4) can be STAs as described herein or equivalents, and gateway devices (1050B-0 to -2) can be APs as described herein or equivalents. Gateway devices 1050B-0 to -2 can have overlapping operating regions. Thus, as local devices (1050-0 to -4) are added to an operating environment, such devices (1050-0 to -4) can associate with one of the gateway devices (1050B-0 to -2).

In the embodiment shown, local devices (1050A-0 to -3) can be Internet-of-things (IoT) type devices, such as lighting devices 1050A-0, locking devices 1050A-1, entertainment devices 1050A-2, security devices 1050A-3, instrumentation devices 1050A-4, as but a few of many possible examples. As each local device (1050A-0 to -3) is added to the operating environment, it can monitor for broadcasts from gateways devices (1050B-0 to -2) that include throughput information, and then select one for association as described herein and equivalents.

Embodiments can include a STA associating with one of multiple APs in a dense operating environment based on throughput information broadcast by all such APs, and thus shape or organize traffic in a predetermined way.

Embodiments can include a STA selecting from among APs having a lowest available capacity for association, thus enabling one or more other APs to remain with relatively high throughput for higher traffic devices that may join in the future.

Embodiments can include a STA selecting from among APs operating with air time fairness. In such an arrangement, STAs can tend to be evenly distributed among a set of APs.

Embodiments can limit adverse effects of high-rate STAs joining a dense operating environment, as compared to conventional contention based access methods.

These and other advantages would be evident to those skilled in the art.

While embodiments have included a broadcast transmission from an AP that includes throughput value for that AP, alternate embodiments can include broadcast transmissions that include throughput data for more than one AP.

While throughput data can include air time amounts, throughput data can also include other data, such as transmit power at the AP and/or receive power at the AP for other devices (e.g., STAs).

While embodiments have described wireless environments compatible with IEEE 802.11 wireless standards, alternate embodiments can include operations according to other standards. In such alternate embodiments, an AP can be a device that controls access to a network, as well as transmission with its network. STAs are devices that may be added to the network with permission from the AP (e.g., association).

Embodiments can include methods, devices and systems that include, by operation of an AP, between transmissions of a periodic beacon frame, communicating with each associated STAs, from communications with the STAs determining connection information for all associated STAs, and generating an IE that includes the connection information for all associated STAs. During a beacon transmission period, a beacon frame can be transmitted a beacon frame that includes a MAC header, a frame body, and a frame check sequence. The frame body includes the IE.

Embodiments can include methods, devices and systems that include radio circuits configured to transmit and receive wireless communications; communication circuits configured to associate with STAs, construct beacon frames that include a MAC header, a frame body having an IE comprising connection information for all associated STAs, and a frame check sequence, and periodically transmit the beacon frames. A controller can be configured to determine the connection information for each associated STA in response to communications with the associated STAs.

Embodiments can include methods, devices and systems can include at least one AP configured to associate with STAs, determine connection information for each associated STA in response to communications with the associated STAs, and construct beacon frames that include a MAC header, a frame body having an IE comprising connection information for all STAs associated with the AP, and a frame check sequence. A controller can periodically transmit the beacon frames; and an antenna coupled to the AP can configured to receive and transmit wireless signals, including transmitting broadcast transmissions comprising the beacon frames.

Methods, devices and systems according to embodiments can include determining connection information includes determining a load on the AP comprising a number of STAs associated with the AP.

Methods, devices and systems according to embodiments can include determining connection information includes determining a throughput for each STA associated with the AP. An IE can include the throughput for each STA associated with the AP.

Methods, devices and systems according to embodiments can include a throughput for each STA including an average rate of data transfer over a same predetermined amount of time.

Methods, devices and systems according to embodiments can include determining connection information by determining a metric for download transmissions to each associated STA and upload transmissions from each associated STA.

Methods, devices and systems according to embodiments can include determining a received signal strength indication for each STA associated with the AP.

Methods, devices and systems according to embodiments can include determining connection information for each associated STA by determining a physical data rate for each associated STA based on any selected from the group of: a received signal strength indication, a modulation scheme and a coding rate.

Methods, devices and systems according to embodiments can include radio circuits are compatible with at least one IEEE 802.11 wireless standard.

Methods, devices and systems according to embodiments can include a plurality of APs, each AP periodically transmitting its own beacon frame comprising its own connection information comprising information corresponding to its associated STAs.

Methods, devices and systems according to embodiments can include at least one unassociated STA configured to receive beacon frames from each of a plurality of APs, determine initial AP candidates for association based on received signal strength for the APs, determine final AP candidates from the initial AP candidates based on estimated effect were the STA to associate with the AP candidate, and randomly selecting an AP for association from the final AP candidates. An estimated effect can be selected from the group of: AP load, aggregate AP throughput and total air time for the AP.

It should be appreciated that reference throughout this specification to “one embodiment” or “an embodiment” means that a particular feature, structure or characteristic described in connection with the embodiment is included in at least one embodiment of the present invention. Therefore, it is emphasized and should be appreciated that two or more references to “an embodiment” or “one embodiment” or “an alternative embodiment” in various portions of this specification are not necessarily all referring to the same embodiment. Furthermore, the particular features, structures or characteristics may be combined as suitable in one or more embodiments of the invention.

Similarly, it should be appreciated that in the foregoing description of exemplary embodiments of the invention, various features of the invention are sometimes grouped together in a single embodiment, figure, or description thereof for the purpose of streamlining the disclosure aiding in the understanding of one or more of the various inventive aspects. This method of disclosure, however, is not to be interpreted as reflecting an intention that the claims require more features than are expressly recited in each claim. Rather, inventive aspects lie in less than all features of a single foregoing disclosed embodiment. Thus, the claims following the detailed description are hereby expressly incorporated into this detailed description, with each claim standing on its own as a separate embodiment of this invention.

While this invention has been described with reference to illustrative embodiments, this description is not intended to be construed in a limiting sense. Various modifications and combinations of the illustrative embodiments, as well as other embodiments of the invention, will be apparent to persons skilled in the art upon reference to the description. It is therefore intended that the appended claims encompass any such modifications or embodiments.

1. A method, comprising:
by operation of an access point device (AP):
between transmissions of a periodic beacon frame, communicating with associated station devices (STAs),
from communications with the STAs determining connection information for all associated STAs, and
generating an information element (IE) that includes the connection information for all associated STAs,
during a beacon transmission period, transmitting a beacon frame that includes
a media access control (MAC) header,
a frame body, and
a frame check sequence; wherein
the frame body includes the IE.

2. The method of claim 1, wherein:
determining connection information includes determining a load for each AP comprising a number of STAs associated with the AP.

3. The method of claim 1, wherein
determining connection information includes determining a data throughput for each STA associated with the AP, and
the IE includes the throughput for each STA associated with the AP.

4. The method of claim 3, wherein:
the throughput for each STA includes an average rate of data transfer over a same predetermined amount of time.

5. The method of claim 1, wherein:
determining connection information includes determining a metric for download transmissions from the AP to each associated STA and upload transmissions from each associated STA to the AP.

6. The method of claim 1, wherein:
determining connection information includes determining a received signal strength indication for each STA associated with the AP.

7. The method of claim 1, wherein:
determining connection information for each associated STA includes determining a physical data rate for each associated STA based on any selected from the group of: a received signal strength indication, a modulation scheme and a coding rate.

8. A device, comprising:
radio circuits configured to transmit and receive wireless communications;
communication circuits configured to
associate with station devices (STAs),
construct beacon frames that include
a media access control (MAC) header,
a frame body having an information element (IE) comprising connection information for all STAs associated with the device, and
a frame check sequence, and
periodically transmit the beacon frames; and
a controller configured to determine the connection information for each associated STA in response to communications with the associated STAs.

9. The device of claim 8, wherein:
the radio circuits are compatible with at least one IEEE 802.11wireless standard.

10. The device of claim 8, wherein:
the connection information includes a load level for the device comprising a number STAs associated with the device.

11. The device of claim 8, wherein:
the connection information comprises a throughput value for each STA associated with the AP.

12. The device of claim 11, wherein:
the throughput for each STA includes an average rate of data transfer between the STA and the device over a same predetermined amount of time.

13. The device of claim 11, wherein:
the throughput for each STA includes a metric for download transmissions to each associated STA and upload transmissions from each associated STA.

14. The device of claim 8, wherein:
the controller is configured to determine the connection information for each associated STA based on any selected from the group of: a received signal strength indication, a modulation scheme and a coding rate.

15. A system, comprising:
at least one access point device (AP) configured to
associate with station devices (STAs),
determine connection information for each associated STA in response to communications with the associated STAs,
construct beacon frames that include
a media access control (MAC) header,
a frame body having an information element (IE) comprising connection information for all STAs associated with the AP, and
a frame check sequence, and
periodically transmit the beacon frames; and
an antenna coupled to the AP can configured to receive and transmit wireless signals, including transmitting broadcast transmissions comprising the beacon frames.

16. The system of claim 15, wherein:
the connection information includes a load level for the AP comprising a number STAs associated with the AP.

17. The system claim 15, wherein:
the connection information comprises a throughput value for each STA associated with the AP.

18. The system of claim 15, wherein:
determining connection information includes determining a received signal strength indication for each STA associated with the AP.

19. The system of claim 15, wherein:
the at least one AP includes a plurality of APs, each AP periodically transmitting its own beacon frame comprising its own connection information comprising information corresponding to its associated STAs.

20. The system of claim 19, further including:
at least one unassociated STA configured to
receive beacon frames from each AP,
determine initial AP candidates for association based on received signal strength for the APs,
determine final AP candidates from the initial AP candidates based on estimated effect were the STA to associate with the AP candidate, and
randomly selecting an AP for association from the final AP candidates; wherein
the estimated effect is selected from the group of: AP load, aggregate AP throughput and total air time for the AP.
